(19) United States
(12) Patent Application Publication
(10) Pub. No.: US 2018/0060662 A1
(43) Pub. Date: Mar. 1, 2018

(54) METHOD AND SYSTEM FOR REAL TIME OBJECT RECOGNITION USING MODIFIED NEURAL NETWORKS ALGORITHM

(71) Applicant: Agrima Infotech India Pvt Ltd., Cochin (IN)

(72) Inventors: Nikhil DHARMAN, Cochin (IN); Anoop BALAKRISHNAN, Cochin (IN); Arun RAVI, Cochin (IN)

(21) Appl. No.: 15/686,078

(22) Filed: Aug. 24, 2017

(30) Foreign Application Priority Data
Aug. 30, 2016 (IN) 201641029554

(51) Int. Cl. G06K 9/00; G06K 9/66; G06T 7/10; G09B 19/00

(52) U.S. Cl. CPC G06K 9/00671; G06K 9/66; G09B 19/0092; G06T 7/10; G06K 9/00456

(57) ABSTRACT

The present disclosure provides a system for an object recognition system for real time recognition of one or more objects captured in an image of one or more images. The object recognition system includes a first step of receiving the one or more images of the one or more objects. In addition, the object recognition system includes another step of analyzing each image of the one or more images. Further, the object recognition system includes yet another step of creating one or more models. Furthermore, the object recognition system includes yet another step of segmenting. The object recognition system includes yet another step of matching the one or more segmented objects with the one or more models. The object recognition system includes yet another step of recognizing the one or more objects. The object recognition system includes displays one or more information. The object recognition system calculates a probability score.

### TECHNICAL FIELD

The present disclosure relates to the field of digital image recognition and, in particular, relates to a method and system for real time object recognition using modified neural networks algorithm.

### BACKGROUND

Over the last few years, object recognition technologies have made immense progression for use in various day to day applications. These applications include face recognition, vehicle recognition, product recognition and the like. In general, the object recognition refers to recognition of one or more objects in an image. Traditionally, the object recognition is performed by capturing an image of the one or more objects of interest and recognizing the image through various conventional algorithms. These algorithms take the image as an input and perform the analysis on the image to provide the results based on information associated with the image. In an example, one of the algorithms includes a neural networks algorithm.

Nowadays, the demand for object recognition in food based technologies is increasing by the minute. The food industry is an ever growing industry with the introduction in a number of food based mobile applications. These applications allow the users to make food at their premises by seeking guidance from these web based platforms. In most cases, not every user has the knowledge about all the recipes and the skill required for making these recipes. Also, the user may want to know different varieties of recipes which can be made from a particular type of ingredient. This kind of knowledge may help the user in preparing and serving different kinds of dishes to others.

Several methods and systems exist in the art which performs recognition of objects for various purposes. In US Publication No. 20140095479 A1, a method, device and system for generation of a list of recipe recommendations is provided. The system determines the type and quantity of ingredients available to a user of a mobile computing device. In addition, a camera is used to capture images of the available ingredients for analysis. Further, the list of recipes is generated based on type of ingredient, quantity of ingredient, meal preferences of the user and the context of the meal.

In U.S. Pat. No. 9,195,896 B2, a method and system for image recognition is provided. The system acquires image information for an object to be recognized at a terminal device. The system transfers the image to a server. The server applies feature recognition techniques to the image information and provides a recognition result. Further, the result is presented by the server at the terminal device.

In U.S. Pat. No. 8,254,670 B2, a method for classification of object based upon fusion of remote sensing and natural imaging system is provided. The method includes detection of an object using the remote sensing system. An image including the object is generated using the natural imaging system is generated. Further, the image represented in either pixel or transformed space is compared to a plurality of templates via a competition based neural network learning algorithm. Each of the plurality of templates has an associated label determined statistically. Accordingly, the template with the closest match is determined. In addition, the image may be assigned the label with the relative location of object, relative speed of the object and the label of the template determined statistically to be the closest match to the image.

The above mentioned prior arts for object recognition bear several disadvantages. These prior arts do not perform a segmentation of the objects in the image in real time. In addition, these prior arts do not perform creation of models of images in real time. Moreover, these prior arts do not provide highly accurate results. The low accuracy of the results leads to false recognition of objects. Further, these prior arts do not recommend the users with the list of recipes based on a single ingredient in real time. Furthermore, these prior arts do not provide accurate tagging of the objects to be recognized.

In light of the above stated discussion, there is a need for a method and system which overcomes the above stated disadvantages.

### SUMMARY

In a first example, a computer-implemented method is provided. The computer-implemented method for an object recognition system for real time recognition of one or more objects captured in an image of one or more images. The computer-implemented method may include a first step of receiving the one or more images of the one or more objects. In addition, the computer-implemented method may include a second step of analysis of each image of the one or more images of the one or more objects. Moreover, the computer-implemented method may include a third step of creation of one or more models of the one or more object in real time. Further, the computer-implemented method may include a fourth step of segmentation of the one or more objects to form one o more segmented objects. Furthermore, the computer-implemented method may include a fifth step of matching the one or more segmented objects with the one or more models of the one or more objects. Also, the computer-implemented method may include a sixth step of recognition of the one or more objects. In addition, the computer-implemented method may include a seventh step of displaying one or more information associated with each object of the one or more objects based on the matching. Moreover, the computer-implemented method may include a eighth step of calculation of a probability score for each of recognized one or more objects in real time. The one or more images may be captured in real time. The analysis of each image of the one or more images may be done in real time. The one or more models of the one or more objects may correspond to the one or more images of the one or more objects. The segmentation may be done by dividing each object of the one or more objects in the one or more images. The matching may be done to check a closeness of the one or more objects with the one or more models of the one or more objects. The recognition may be done by utilizing a modified neural networks algorithm. The modified neural networks algorithm may be a machine learning language based algorithm. The modified neural networks algorithm may perform supervised and unsupervised learning. The one or more information may be displayed in real time. The calculation of the probability score may be done to show accuracy of the one or more information.

In an embodiment of present disclosure, the computer-implemented method may include the one or more objects. The one or more objects include a collection of matter. The collection of matter includes one or more food ingredients, one or more materialistic items and one or more other objects. The one or more images of the one or more objects may be captured through a camera associated with one or more portable communication devices.

In an embodiment of present disclosure, the computer-implemented method may include creation of the one or more models. The creation of the one or more models may be based on one or more categories of the one or more objects. The one or more categories of the one or more objects may include types of the one or more objects, shapes of the one or more objects and color of the one or more objects.

In an embodiment of present disclosure, the computer-implemented method may include recognition of the one or more objects. The recognition of the one or more objects may be done in one or more modes. The one or more modes include an online mode and an offline mode. The one or more modes may be accessed by the one or more portable communication devices

In an embodiment of present disclosure, the computer-implemented method may include recommendation of one or more recipes in real time. The recommendation of the one or more recipes may be done corresponding to recognition of the one or more food ingredients in real time. The recommendation may be done to select a recipe of the one or more recipes.

In an embodiment of present disclosure, the computer-implemented method may include segmentation of the one or more objects in the one or more images. The segmentation of the one or more objects in the one or more images may be done by cropping images of each object of the one or more objects in one or more images. The segmentation may be done for analyzing each object of the one or more objects separately.

In an embodiment of present disclosure, the computer-implemented method may include one or more information. The one or more information include a keyword associated with each of the recognized one or more objects and the probability score of the one or more objects. The one or more information include one or more tags for each object of the one or more objects.

In an embodiment of present disclosure, the computer-implemented method may include matching of the one or more segmented objects with the one or more models of the one or more objects. The matching may be done by comparing one or more attributes of the one or more objects with the one or more models of the one or more objects. The one or more attributes of the one or more objects may be extracted in real time.

In an embodiment of present disclosure, the computer-implemented method may include storage of the one or more images, the one or more segmented objects, the one or more models and the one or more recipes. The storage may be done in real time.

In an embodiment of present disclosure, the computer-implemented method may include updating the one or more images, the one or more segmented objects, the one or more models and the one or more recipes. The updating may be done in real time.

In a second example, a computer system is provided. The computer system may include one or more processors and a memory coupled to the one or more processors. The memory may store instructions which, when executed by the one or more processors, may cause the one or more processors to perform a method. The method is an object recognition system for real time recognition of one or more objects captured in an image of one or more images. The method may include a first step of receiving the one or more images of the one or more objects. In addition, the method may include a second step of analysis of each image of the one or more images of the one or more objects. Moreover, the method may include a third step of creation of one or more models of the one or more object in real time. Further, the method may include a fourth step of segmentation of the one or more objects to form one o more segmented objects. Furthermore, the method may include a fifth step of matching the one or more segmented objects with the one or more models of the one or more objects. Also, the method may include a sixth step of recognition of the one or more objects. In addition, the method may include a seventh step of displaying one or more information associated with each object of the one or more objects based on the matching. Moreover, the method may include a eighth step of calculation of a probability score for each of recognized one or more objects in real time. The one or more images may be captured in real time. The analysis of each image of the one or more images may be done in real time. The one or more models of the one or more objects may correspond to the one or more images of the one or more objects. The segmentation may be done by dividing each object of the one or more objects in the one or more images. The matching may be done to check a closeness of the one or more objects with the one or more models of the one or more objects. The recognition may be done by utilizing a modified neural networks algorithm. The modified neural networks algorithm may be a machine learning language based algorithm. The modified neural networks algorithm may perform supervised and unsupervised learning. The one or more information may be displayed in real time. The calculation of the probability score may be done to show accuracy of the one or more information.

In an embodiment of present disclosure, the method may include the one or more objects. The one or more objects include a collection of matter. The collection of matter includes one or more food ingredients, one or more materialistic items and one or more other objects. The one or more images of the one or more objects may be captured through a camera associated with one or more portable communication devices.

In an embodiment of present disclosure, the method may include creation of the one or more models. The creation of the one or more models may be based on one or more categories of the one or more objects. The one or more categories of the one or more objects may include types of the one or more objects, shapes of the one or more objects and color of the one or more objects.

In an embodiment of present disclosure, the method may include recognition of the one or more objects. The recognition of the one or more objects may be done in one or more modes. The one or more modes include an online mode and an offline mode. The one or more modes may be accessed by the one or more portable communication devices

In an embodiment of present disclosure, the method may include recommendation of one or more recipes in real time. The recommendation of the one or more recipes may be done corresponding to recognition of the one or more food ingredients in real time. The recommendation may be done to select a recipe of the one or more recipes.

In an embodiment of present disclosure, the method may include segmentation of the one or more objects in the one or more images. The segmentation of the one or more objects in the one or more images may be done by cropping images of each object of the one or more objects in one or more images. The segmentation may be done for analyzing each object of the one or more objects separately.

In an embodiment of present disclosure, the method may include one or more information. The one or more information include a keyword associated with each of the recognized one or more objects and the probability score of the one or more objects. The one or more information include one or more tags for each object of the one or more objects.

In an embodiment of present disclosure, the method may include matching of the one or more segmented objects with the one or more models of the one or more objects. The matching may be done by comparing one or more attributes of the one or more objects with the one or more models of the one or more objects. The one or more attributes of the one or more objects may be extracted in real time.

In an embodiment of present disclosure, the method may include storage of the one or more images, the one or more segmented objects, the one or more models and the one or more recipes. The storage may be done in real time.

In an embodiment of present disclosure, the method may include updating the one or more images, the one or more segmented objects, the one or more models and the one or more recipes. The updating may be done in real time.

In a third example, a computer-readable storage medium is provided. The computer-readable storage medium encodes computer executable instructions that, when executed by at least one processor, performs a method. The method is an object recognition system for real time recognition of one or more objects captured in an image of one or more images. The method may include a first step of receiving the one or more images of the one or more objects. In addition, the method may include a second step of analysis of each image of the one or more images of the one or more objects. Moreover, the method may include a third step of creation of one or more models of the one or more object in real time. Further, the method may include a fourth step of segmentation of the one or more objects to form one o more segmented objects. Furthermore, the method may include a fifth step of matching the one or more segmented objects with the one or more models of the one or more objects. Also, the method may include a sixth step of recognition of the one or more objects. In addition, the method may include a seventh step of displaying one or more information associated with each object of the one or more objects based on the matching. Moreover, the method may include a eighth step of calculation of a probability score for each of recognized one or more objects in real time. The one or more images may be captured in real time. The analysis of each image of the one or more images may be done in real time. The one or more models of the one or more objects may correspond to the one or more images of the one or more objects. The segmentation may be done by dividing each object of the one or more objects in the one or more images. The matching may be done to check a closeness of the one or more objects with the one or more models of the one or more objects. The recognition may be done by utilizing a modified neural networks algorithm. The modified neural networks algorithm may be a machine learning language based algorithm. The modified neural networks algorithm may perform supervised and unsupervised learning. The one or more information may be displayed in real time. The calculation of the probability score may be done to show accuracy of the one or more information.

### BRIEF DESCRIPTION OF FIGURES

Having thus described the invention in general terms, reference will now be made to the accompanying figures, wherein:

FIG. 1A and FIG. 1B illustrates an interaction between a user and one or more components for real time recognition of one or more objects, in accordance with various embodiments of the present disclosure;

FIG. 2 illustrates a flow chart of a method for recognition of the one or more objects, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

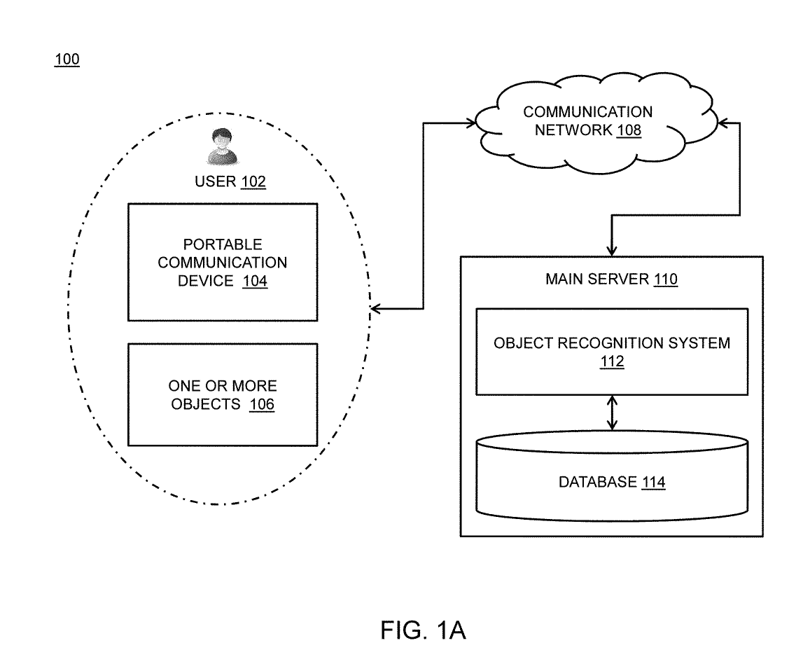

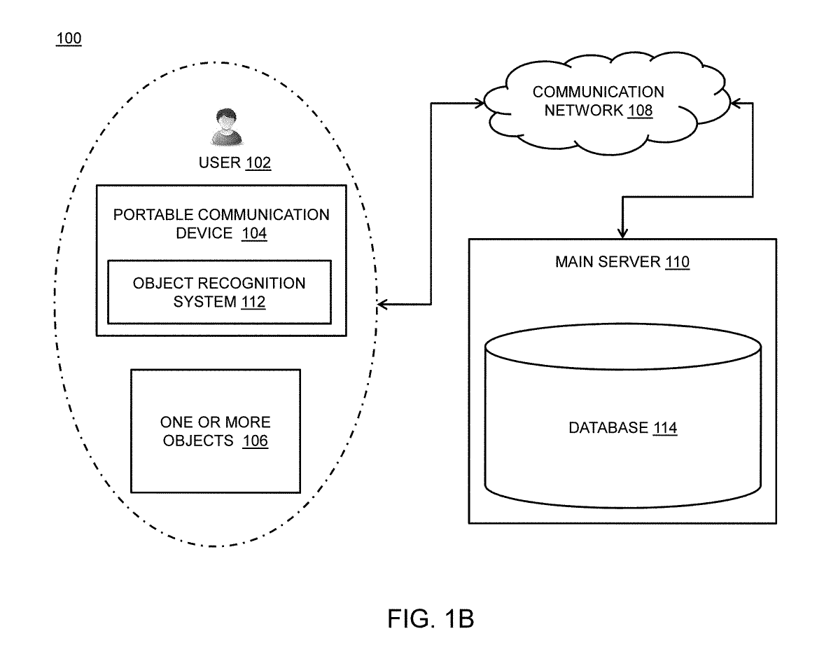

FIG. 1A illustrates an interaction 100 between a user and one or more components for real time recognition of one or more objects, in accordance with various embodiments of the present disclosure. The interaction 100 enables the recognition of the one or more objects for various purposes (provided below in the provisional patent application). The recognition of the one or more objects corresponds to real time accurate identification of the one or more objects captured in an image by the user. In addition, the recognition of the one or more objects is done in real time. Also, the recognition of the one or more objects is done by utilizing a modified neural networks algorithm.

The interaction 100 includes a portable communication device 104, one or more objects 106, a communication network 108, a main server 110, an object recognition system 112 and a database 114. The portable communication device 104 is associated with a user 102. The user 102 is an owner of the portable communication device 104. The user 102 may be any person or individual interested in cooking new recipes, recognizing objects and the like. In addition, the user 102 accesses the portable communication device 104 in real time. The portable communication device 104 is any type of electronic device having an image capturing application.

Examples of the portable communication device 104 includes a smart phone, a tablet, a desktop computer, a laptop or any other electronic portable device capable of providing communication services to the user 102. In addition, the portable communication device 104 runs on a specific operating system. Examples of the types of the operating system include but may not be limited to Android OS, iOS, BADA, Windows, Symbian and Blackberry OS. Moreover, the portable communication device 104 includes one or more modes. Further, the one or more modes include an online mode and an offline mode. Furthermore, the online mode includes internet facility. Moreover, the offline mode includes a storage device. In an embodiment of the present disclosure, the portable communication device 104 is presently connected to the internet. In an embodiment of the present disclosure, the portable communication device 104 is connected to the internet through a WiFi connection. In another embodiment of the present disclosure, the portable communication device 104 is connected to the internet through a data connection provided by a telecom service provider. In yet another embodiment of the resent disclosure, the portable communication device 104 is connected offline through the storage device.

In an embodiment of the present disclosure, the portable communication device 104 is connected to an internet broadband system, a local area network, a wide area network, a digital or analog cable television network or any other communication network presently known in the art. The internet broadband system may be a wired or a wireless system. In an embodiment of the present disclosure, the portable communication device 104 includes one or more browsers pre-installed in the portable communication device 104. The one or more browsers enable the user 102 to access the internet. Further, the user 102 accesses the one or more browsers to access a web based platform. The web based platform enables the real time recognition of the one or more objects in the real time.

In another embodiment of the present disclosure, the portable communication device 104 includes an application installed on the portable communication device 104. The application corresponds to a mobile based application. The mobile based application is configured to perform the real time recognition of the one or more objects 106 in the real time. In addition, the mobile based application is associated with a specific type of operating system. The type of operating system is based on the operating system of the portable communication device 104. In an example, the mobile based application may be an android application, an iOS application, a windows application, a blackberry application and the like.

In an embodiment of the present disclosure, the mobile based application is pre-installed on the portable communication device 104. In another embodiment of the present disclosure, the mobile based application is installed manually by the user 102. Further, the user 102 accesses the mobile based application on the portable communication device 104. In addition, the mobile based application is associated with an application server. The application server performs a plurality of functions for the recognition of the one or more objects 106 in the real time.

Further, the one or more objects 106 lie in a vicinity of the user 102 and the portable communication device 104. The one or more objects 106 may be any type of object lying in the vicinity of the user 102. In an embodiment of the present disclosure, the type of the one or more objects 106 includes one or more food ingredients, one or more materialistic items and one or more other objects. In an example, the one or more objects 106 include one or more fruits, one or more vegetables, one or more food containers and the like. In an embodiment of the present disclosure, the one or more objects 106 correspond to objects to be recognized for the user 102 in real time.

Furthermore, the portable communication device 104 is associated with the main server 110. In an embodiment of the present disclosure, the portable communication device 104 is associated with the main server 110 through the communication network 108. In addition, the communication network 108 enables the portable communication device 104 to connect to the internet. In an embodiment of the present disclosure, the user 102 accesses the mobile based application or the web based platform on the corresponding portable communication device 104 through the communication network 108. The communication network 108 provides a medium for communication between the main server 110 and the portable communication device 104. Also, the communication network 108 enables transfer of information between the portable communication device 104 and the main server 110.

Further, the medium for communication may be infrared, microwave, radio frequency (RF) and the like. The communication network 108 include but may not be limited to a local area network, a metropolitan area network, a wide area network, a virtual private network, a global area network, a home area network or any other communication network presently known in the art. The communication network 108 is a structure of various nodes or communication devices connected to each other through a network topology method. Examples of the network topology include a bus topology, a star topology, a mesh topology and the like.

Furthermore, the main server 110 includes the object recognition system 112 and the database 114. In an embodiment of the present disclosure, the object recognition system 112 is installed on the portable communication device 104. The main server 110 controls the one or more operations performed by the object recognition system 112. The object recognition system 112 performs the real time recognition of the one or more objects 106 in the real time. In addition, the object recognition system 112 performs a number of steps. Going further, the user 102 accesses the mobile based application on the portable communication device 104. In an embodiment of the present disclosure, the user 102 accesses a website associated with the web based platform on a browser of the one or more browsers installed on the portable communication device 104.

The user 102 accesses the mobile based application for capturing an image of the one or more objects 106 located in the vicinity of the user 102 in the real time. The mobile based application prompts the user 102 to take the image of the one or more objects 106. In an embodiment of the present disclosure, the user 102 may directly take the image of the one or more objects 106 through a camera associated with the portable communication device 104. In addition, the mobile based application accesses the camera of the portable communication device 104 for allowing the user 102 to capture the image of the one or more objects 106.

The mobile based application is associated with the main server 110. In addition, the mobile based application is linked with the main server 110. Moreover, the mobile based application is linked with the main server 110 through the communication network 108. Further, the user 102 may capture any number of images of the one or more objects 106 based on his or her choice. Accordingly, the mobile based application allows the user 102 to upload the image of the one or more objects 106. The user 102 uploads the image of the one or more objects 106 to be recognized. In another embodiment of the present disclosure, the one or more objects 106 are directly scanned by utilizing a video camera associated with the portable communication device 104 of the user 102.

Accordingly, the mobile based application on the portable communication device 104 transfers the image of the one or more objects 106 to the main server 110 in the real time. The main server 110 is located in a remote location away from the portable communication device 104. The object recognition system 112 in the main server 110 creates one or more models of the one or more objects 106 in real time. In addition, the one or more models of the one or more objects 106 corresponds to one or more different images of the one or more objects based on one or more category of the one or more objects 106. In an embodiment of the present disclosure, the one or more category of the one or more objects 106 corresponds to a type of the one or more objects 106, a shape of the one or more objects 106 and a color of the one or more objects 106.

In an embodiment of the present disclosure, the one or more models are created and stored in the database 114. In an embodiment of the present disclosure, the one or more models are created by an administrator. Further, the object recognition system 112 in the main server 110 receives the image of the one or more objects 106 captured in the real time. In addition, the object recognition system 112 receives the image of the one or more objects 106 through the communication network 108. The image of the one or more objects 106 is captured by the user 102 accessing the portable communication device 104 in real time.

In an embodiment of the present disclosure, the main server 110 triggers an algorithm as soon as the image is received from the portable communication device 104. The algorithm corresponds to the modified neural networks algorithm. In an embodiment of the present disclosure, the modified neural networks algorithm performs supervised and unsupervised learning. The modified neural networks algorithm is a machine learning based algorithm. Also, the modified neural networks algorithm includes a back propagation algorithm for reducing error between desired output and actual output. The image is represented as pixels or transformed space to the main server 110.

Further, the object recognition system 112 performs segmentation of the one or more objects 106 in the received image in real time. The segmentation is done by dividing each object of the one or more objects 106 in the image. In an embodiment of the present disclosure, the segmentation is done by cropping image of each object of the one or more objects 106 in real time. The segmentation is done for analyzing each object of the one or more objects 106 separately.

Furthermore, the object recognition system 112 matches each of the one or more segmented objects 106 with the one or more models of the one or more objects 106 in real time. The matching is done for checking a closeness of the one or more objects 106 with the one or more models of the one or more objects 106. In an embodiment of the present disclosure, the comparison of the one or more segmented objects 106 with the one or more models is done by comparing one or more attributes of the one or more objects 106 with the one or more models in real time. In an embodiment of the present disclosure, the one or more attributes of the one or more objects 106 are extracted in real time. In an embodiment of the present disclosure, the real time recognition of the one or more objects 106 is done by utilizing the modified neural networks algorithm.

Accordingly, the object recognition system 112 displays one or more information associated with each of the recognized one or more objects based on the matching in real time. In an embodiment of the present disclosure, the one or more information includes a keyword associated with each of the recognized one or more objects 106 and a probability score for each of the one or more objects 106. In addition, the one or more information includes one or more tags for each of the one or more objects 106. The one or more information provides details of each of the recognized one or more objects to the user 102 in the real time. The one or more information is displayed on the portable communication device 104 in the real time. Further, the recognition of the one or more objects is done in one or more modes. Furthermore, the one or more modes include the online mode and the offline mode. Moreover, the online mode includes the internet connectivity. Further, the offline mode includes connectivity to the storage device. Furthermore, the one or more modes are accessed by the one or more portable communication devices 104.

In an embodiment of the present disclosure, the object recognition system 112 may not recognize each image of a plurality of images received from the portable communication device 104. In an example, the object recognition system 112 receives 15 to 20 images in real time. Accordingly, the object recognition system 112 recognizes around 90% of the received images in real time.

Going further, the object recognition system 112 calculates a probability score for each of the recognized one or more objects 106 in real time. The probability score is calculated for showing accuracy of the displayed one or more information in real time. In addition, the probability score is based on the matching of the one or more objects 106 with the one or more models. In an embodiment of the present disclosure, the probability score is denoted by a number. The number may be a fraction. In an example, the probability score of 0.91 denotes 91% probability of closeness.

The object recognition system 112 recommends one or more recipes to the user 102 in real time. The recommendation of the one or more recipes is done corresponding to the recognition of the one or more food ingredients in real time. In addition, the recommendation is done for allowing the user 102 to select a recipe of the one or more recipes based on a choice of the user 102. The recommended one or more recipes are displayed to the user 102 on the portable communication device 104. Further, the object recognition system 112 updates the one or more information, the recognized one or more objects 106 and the captured image of the one or more objects 106 in the real time. In addition, the object recognition system 112 updates the one or more models of the one or more objects 106.

Furthermore, the object recognition system 112 stores the captured image of the one or more objects 106 and the one or more segmented objects 106 in real time. In addition, the object recognition system 112 stores the one or more models and the one or more recipes recommended to the user 102 in real time. The storage is done in the database 114.

It may be noted that in FIG. 1A and FIG. 1B, the user 102 is associated with the portable communication device 104; however, those skilled in the art would appreciate that more number of users are associated with more number of communication devices.

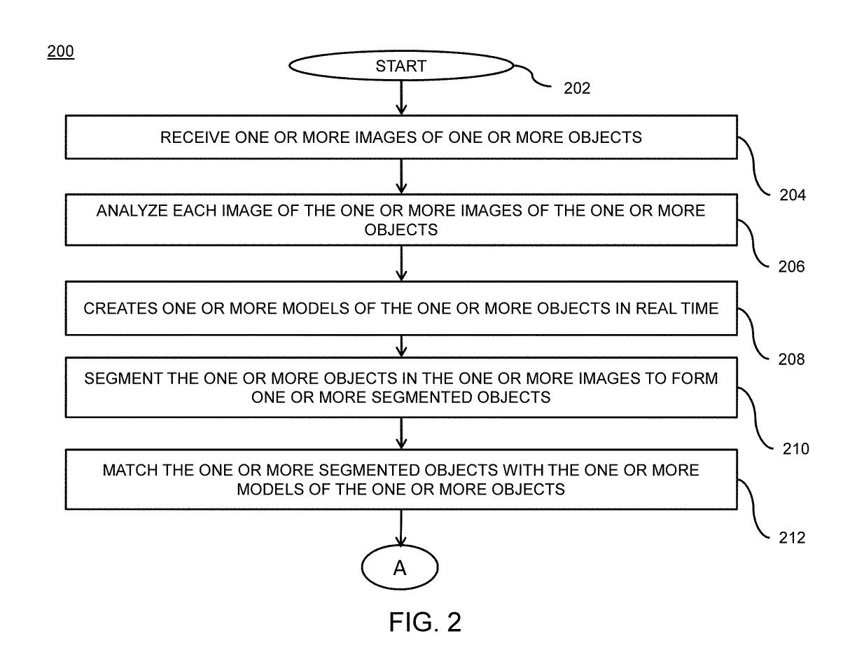

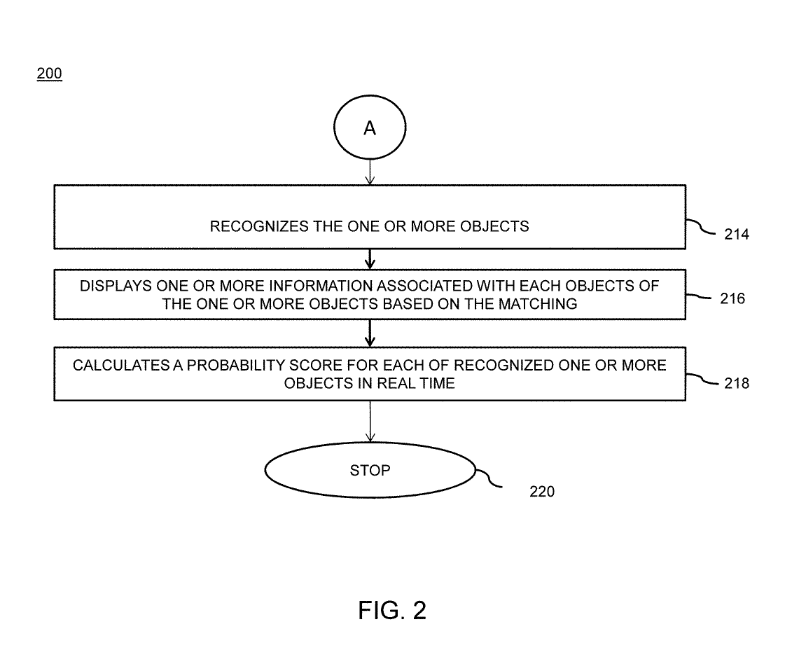

FIG. 2 illustrates a flow chart of a method for recognition of the one or more objects, in accordance with various embodiments of the present disclosure. It may be noted that to explain the process steps of the flowchart 200, references will be made to the system elements of FIG. 1A and FIG. 1B It may be noted that the flowchart 200 may have lesser or more number of steps.

The flowchart 200 initiates at step 202. Following step 202, at step 204, the object recognition system 112 receives the one or more images of the one or more objects 106 in real time. At step 206, the object recognition system 112 analyzes each image of the one or more images of the one or more objects 106. At step 208, the object recognition system 112 creates one or more models of the one or more objects 106 in real time. At step 210, the object recognition system 112 segments the one or more objects 106 in one or more images to form one or more segmented objects. At step 212, the object recognition system 112 matches the one or more segmented objects with the one or more models of the one or more objects 106. At step 214, the object recognition system 112 recognizes the one or more objects 106. At step 216, the object recognition system 112 displays one or more information associated with each object of the one or more objects 106 based on the matching. At step 218, the object recognition system 112 calculates a probability score for each of recognized one or more objects in real time. The flow chart 200 terminates at step 220.

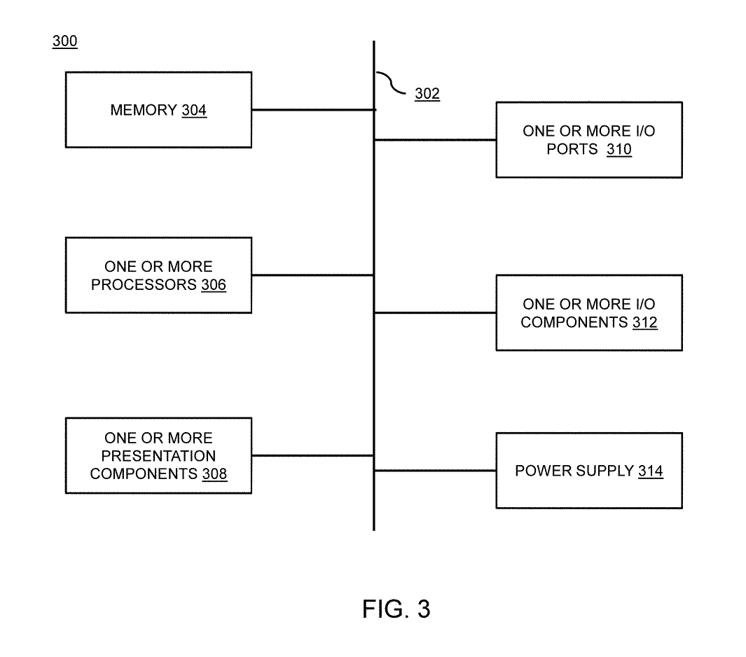

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention.

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for real time recognition of one or more objects captured in an image of one or more images, the computer-implemented method comprising:
receiving, at an object recognition system with a processor, the one or more images of the one or more objects, wherein the one or more images being captured in real time;
analyzing, at the object recognition system with the processor, each image of the one or more images of the one or more objects, wherein the analysis of each image of the one or more images being done in real time;
creating, at the object recognition system with the processor, one or more models of the one or more objects in real time, wherein the one or more models of the one or more objects corresponds to the one or more images of the one or more objects;
recognizing, at the object recognition system with the processor, the one or more objects, wherein the recognition being done by utilizing a modified neural networks algorithm, wherein the modified neural networks algorithm being a machine learning based algorithm, wherein the modified neural networks algorithm performs supervised and unsupervised learning;
segmenting, at the object recognition system with the processor, the one or more objects in the one or more images to form one or more segmented objects, wherein the segmentation being done by dividing each object of the one or more objects in the one or more images;
matching, at the object recognition system with the processor, the one or more segmented objects with the one or more models of the one or more objects, wherein the matching being done for checking a closeness of the one or more objects with the one or more models of the one or more objects;
displaying, at the object recognition system with the processor, one or more information associated with each object of the one or more objects based on the matching, wherein the one or more information being displayed in real time; and
calculating, at the object recognition system with the processor, a probability score for each of recognized one or more objects in real time, wherein the calculation of the probability score being done to show accuracy of the one or more information.

2. The computer implemented method as recited in claim 1, wherein the one or more objects comprise a collection of matter, wherein the collection of matter comprises one or more food ingredients, one or more materialistic items and one or more other objects, wherein the one or more images of the one or more objects being captured through a camera associated with one or more portable communication devices.

3. The computer implemented method as recited in claim 1, wherein the creation of the one or more models being based on one or more categories of the one or more objects, wherein the one or more categories of the one or more objects comprises of type of the one or more objects, shape of the one or more objects and color of the one or more objects.

4. The computer implemented method as recited in claim 1, wherein the recognition of the one or more objects being done in one or more modes, wherein the one or more modes comprise an online mode and an offline mode, wherein the one or more modes being accessed by the one or more portable communication devices.

5. The computer implemented method as recited in claim 1, further comprising recommending, at the object recognition system with the processor, one or more recipes in real time, wherein the recommendation of the one or more recipes being done corresponding to recognition of the one or more food ingredients in real time, wherein the recommendation being done to select a recipe of the one or more recipes.

6. The computer implemented method as recited in claim 1, wherein the segmentation of the one or more objects in the one or more images being done by cropping images of each object of the one or more objects in the one or more images, wherein the segmentation being done for analyzing each object of the one or more objects separately.

7. The computer implemented method as recited in claim 1, wherein the one or more information comprises a keyword associated with each of the recognized one or more objects, the probability score of the one or more objects and one or more tags for each object of the one or more objects.

8. The computer implemented method as recited in claim 1, wherein the matching of the one or more segmented objects with the one or more models of the one or more objects being done by comparing one or more attributes of the one or more objects with the one or more models of the one or more objects, wherein the one or more attributes of the one or more objects being extracted in real time.

9. The computer implemented method as recited in claim 1, further comprising storing, at the object recognition system with the processor, the one or more images of the one or more objects, the one or more segmented objects, the one or more models and one or more recipes, wherein the storage being done in real time.

10. The computer implemented method as recited in claim 1, further comprising updating, at the object recognition system with the processor, the one or more images of the one or more objects, the one or more segmented objects, the one or more models and one or more recipes, wherein the updation being done in real time.

11. A computer system comprising:
one or more processor; and
a memory coupled to the one or more processors, the memory for storing instructions which, when executed by the one or more processors, cause the one or more processors to perform a method for an object recognition system for real time recognition of one or more objects captured in an image of one or more images, the method comprising:
receiving, at an object recognition system, the one or more images of the one or more objects, wherein the one or more images being captured in real time;
analyzing, at the object recognition system, each image of the one or more images of the one or more objects, wherein the analysis being done in real time;
creating, at the object recognition system, one or more models of the one or more objects in real time, wherein the one or more models of the one or more objects corresponds to the one or more images of the one or more objects;
recognizing, at the object recognition system, the one or more objects, wherein the recognition being done by utilizing a modified neural networks algorithm, wherein the modified neural networks algorithm being a machine learning based algorithm, wherein the modified neural networks algorithm performs supervised and unsupervised learning;
segmenting, at the object recognition system, the one or more objects in the one or more images to form one or more segmented objects, wherein the segmentation being done by dividing each object of the one or more objects in the one or more images;
matching, at the object recognition system, the one or more segmented objects with the one or more models of the one or more objects, wherein the matching being done for checking a closeness of the one or more objects with the one or more models of the one or more objects;
displaying, at the object recognition system, one or more information associated with each object of the one or more objects based on the matching, wherein the one or more information being displayed in real time; and
calculating, at the object recognition system, a probability score for each of the recognized one or more objects in real time, wherein the calculation of the probability score being done to show accuracy of the one or more information.

12. The computer system as recited in claim 11, wherein the one or more objects comprises a collection of matter, wherein the collection of matter comprises one or more food ingredients, one or more materialistic items and one or more other objects, wherein the one or more images of the one or more objects being captured through a camera associated with portable communication devices.

13. The computer system as recited in claim 11, wherein the creation of the one or more models being based on one or more categories of the one or more objects, wherein the one or more categories of the one or more objects comprises of type of the one or more objects, shape of the one or more objects and color of the one or more objects.

14. The computer system as recited in claim 11, wherein the recognition of the one or more objects being done in one or more modes, wherein the one or more modes comprise an online mode and an offline mode, wherein the one or more modes being accessed by the one or more portable communication devices.

15. The computer system as recited in claim 11, further comprising recommending, at the object recognition system, one or more recipes in real time, wherein the recommendation of the one or more recipes being done corresponding to recognition of the one or more food ingredients in real time, wherein the recommendation being done to select a recipe of the one or more recipes.

16. The computer system as recited in claim 11, wherein the segmentation of the one or more objects in the one or more images being done by cropping images of each object of the one or more objects in the one or more images, wherein the segmentation being done for analyzing each object of the one or more objects separately.

17. The computer system as recited in claim 11, wherein the one or more information comprises a keyword associated with each of the recognized one or more objects and the probability score of the one or more objects, wherein the one or more information comprises one or more tags for each object of the one or more objects.

18. The computer system as recited in claim 11, wherein the matching of the one or more segmented objects with the one or more models of the one or more objects being done by comparing one or more attributes of the one or more objects with the one or more models of the one or more objects, wherein the one or more attributes of the one or more objects being extracted in real time.

19. The computer system as recited in claim 11, further comprising storing, at the object recognition system, the one or more images of the one or more objects, the one or more segmented objects, the one or more models and the one or more recipes, wherein the storage being done in real time.

20. A computer-readable storage medium encoding computer executable instructions that, when executed by at least one processor, performs a method for an object recognition system for real time recognition of one or more objects captured in an image of one or more images, the method comprising:
receiving, at the computing device, the one or more images of the one or more objects, wherein the one or more images being captured in real time;
analyzing, at the computing device, each image of the one or more images of the one or more objects, wherein the analysis being done in real time;
creating, at the computing device, one or more models of the one or more objects in real time, wherein the one or more models of the one or more objects corresponds to the one or more images of the one or more objects;
recognizing, at the computing device, the one or more objects, wherein the recognition being done by utilizing a modified neural networks algorithm, wherein the modified neural networks algorithm being a machine learning based algorithm, wherein the modified neural networks algorithm performs supervised and unsupervised learning;
segmenting, at the computing device, the one or more objects in the one or more images to form one or more segmented objects, wherein the segmentation being done by dividing each object of the one or more objects in the one or more images;
matching, at the computing device, the one or more segmented objects with the one or more models of the one or more objects, wherein the matching being done for checking a closeness of the one or more objects with the one or more models of the one or more objects;
displaying, at the computing device, one or more information associated with each object of the one or more objects based on the matching, wherein the one or more information being displayed in real time; and
calculating, at the computing device, a probability score for each of the recognized one or more objects in real time, wherein the calculation of the probability score being done to show accuracy of the one or more information.
